(19) United States
(12) Patent Application Publication
(10) Pub. No.: US 2012/0156433 A1
(43) Pub. Date: Jun. 21, 2012

(54) SILICONE POLYMER SUBSTRATES HAVING IMPROVED BIOLOGICAL RESPONSE FROM HKDCS

(76) Inventors: Sriram N. Natarajan, Bridgewater, NJ (US); Kevin L. Cooper, Flemington, NJ (US)

(21) Appl. No.: 13/325,514

(22) Filed: Dec. 14, 2011

Related U.S. Application Data
(60) Provisional application No. 61/425,520, filed on Dec. 21, 2010.

(51) Int. Cl. B32B 3/00; B44C 1/22

(52) U.S. Cl. 428/152; 216/11

(57) ABSTRACT

A method of altering surface properties of elatomeric polymers by high energy inert gas plasma treatments so as to enhance the proliferation of cells on these surfaces, in particular to enhance the proliferation of hKDCs on such surfaces. The surface properties are altered while the bulk properties of the polymers are unchanged. The unique altered surfaces provide cell adhesion.

This application claims priority to the provisional application Ser. No. 61/425,520, filed Dec. 21, 2010.

### FIELD OF THE INVENTION

The invention relates to a method of surface modification of a polymer substrate in order to enhance the biological response of the surface.

### BACKGROUND OF THE INVENTION

Silicone based polymers are widely used in the medical field due in part to their unique attributes for medical devices and pharmaceutical applications including biocompatibility and strength retention. Silicone polymers are widely used in tissue engineering devices and in scaffolds but the cells do not always attach, proliferate, and grow well on these devices or substrates. Surface engineering of these polymers therefore has a variety of scientific and technological applications that include tissue engineering, regenerative medicine, microfluidics, and lab on chip devices.

Although the specific needs of each tissue are different, many of the same general problems must be solved in adapting silicone polymers as scaffolds for wide ranging applications. This includes controlling cell-surface interactions such as adhesion, migration and differentiation. The process of tissue regeneration is believed to be governed by factors that include the interactions of cells with the surface of the device. Thus, the surface properties of these materials and how such properties are affected by processing are important to understand and control. Processing these polymers by methods that achieve desired bulk properties can alter surface properties in ways that are not anticipated and that may have negative effects on desired biological outcomes. It is therefore desirable to develop processes that can affect only the surface of a polymeric structure or substrate without altering the bulk properties of the polymer.

Plasma treatment is known and has been used to alter the surface properties of polymers without affecting their bulk properties. Specific surface properties like hydrophobicity, chemical structure, and roughness can be tailored to meet target requirements. Some major effects that have been observed in plasma treatment of polymer surfaces are removal of organic contamination, micro and nano scale-etching, cross-linking, and surface chemistry modifications. Plasma techniques for modifying the surface characteristics of many materials are also known. Specific applications for surface modified materials have been described for both microelectronic and medical implant device technology.

In the medical device arts, the use of plasma treatment for implantable medical devices made from biocompatible materials has generally been confined to surface conditioning, i.e., altering functional groups on the surface, without attention to the surface morphology. Descriptions and elaboration of surface modifications for implants and other devices by RF plasmas can be found in the following U.S. Pat. Nos. 3,814,983; 4,929,319, 4,948, 628; 5,055,316; 5,080,924; 5,084,151; 5,217, 743; 5,229,172; 5,246,451; 5,260,093; 5,262,097; 5,364,662; 5,451,428; 5,476, 509; and 5,543,019.

It has been demonstrated that protein adsorption and endothelial cell attachment, spreading, and proliferation are influenced by both chemical and physical properties of the polymer surface (Lee, J-S. et al., Biomater 14:958-960 (1993)). It has also been shown that endothelial cell proliferation and spreading can be enhanced by increasing the oxygen concentration at the polymer surface (Kottke-Marchant, K. et al. J Biomed Mater Res 30:209-220 (1996); Ertel, S. I. et al. J Biomed Mater Res 24:1637-1659 (1990)). In contrast to ion implantation, plasma surface modification is confined to the outermost surface layer. However, a drawback with oxygen and air plasma treatments is the degradation of the material properties as a result of chain scission.

Medical devices that have contact with the human body need an optimal combination of mechanical properties and surface characteristics that result in superior performance in the biological environment. There is then a need in this art for medical devices having modified substrate material surfaces, and methods of producing such surfaces, so that these medical devices have improved performance in biological environments, particularly with respect to promoting desirable cell growth on such surfaces.

### SUMMARY OF THE INVENTION

Accordingly, a method of surface modification of a substrate is disclosed. The method includes providing a biocompatible, non-absorbable elastomeric polymer substrate and applying an RF plasma treatment under an inert atmosphere, resulting in an altered surface having wave-like features. The polymer substrate treated in such a manner has improved cell attachment to the altered surface and growth of cells, including hKDCs, which is important in the area of tissue engineering and kidney tissue engineering.

Another aspect of the present invention is a biocompatible, non-absorbable, elasotomeric polymeric substrate treated by the above-described method and having an altered surface.

The foregoing and other features and advantages of the present invention will become more apparent from the following description and accompanying drawings.

### BRIEF DESCRIPTION OF THE DRAWINGS

FIG. 1 shows the viable cell count analysis on untreated and plasma treated PDMS films obtained as in Example 1.

FIG. 2 shows an AFM image of the wave-like features generated by the methods of the invention.

### DETAILED DESCRIPTION OF THE INVENTION

The methods of the invention provide for the altering of surface topography of polymers, specifically biocompatible, non-absorbable elastomeric polymers, by inert gas plasma treatments, resulting in an enhanced biological response of cells toward the polymer surfaces. The intensity and quality of the plasma to which a target material is exposed produces surface patterns. In order to establish this plasma, low background pressures and relatively low power levels are employed.

The novel methods of the present invention provide for the surface modification of a substrate by providing a biocompatible, non-absorbable elastomeric polymer substrate. The substrate is placed in an inert gas atmosphere and subjected to an RF plasma treatment sufficiently effective to provide the periodic wave-like features on the surface of the substrate. It has been postulated that the plasma treatment alters the physical characteristics of the surface, thereby producing a surface having an increased modulus, while the modulus of the bulk polymer remains substantially unchanged. The modulus mismatch between the surface and bulk polymeric substrate likely provides the wave-like features on the surface of the substrate. The resultant polymer surfaces provide improved cell growth and proliferation for cells, in particular, human kidney-derived cells.

Suitable biocompatible, non-absorbable elastomeric polymers useful in the practice of the present invention include fluoropolymers, polyurethanes, and silicone polymers. In one embodiment, the biocompatible, non-absorbable elastomeric polymer is a silicone polymer, such as polydimethylsiloxane.

The substrate or device may be of any suitable shape for a medical device on which it is desired to grow cells. Examples of suitable substrates and devices include, but are not limited to, medical devices, such as suture anchors, sutures, staples, surgical tacks, clips, plates, screws, and films; tissue engineering scaffolds, such as non-woven felts, woven meshes or fabrics; foams; powders; filters; and cell culture vessels, such as, dishes, flasks, and the like.

Plasma treatment of the surface of the substrates may be accomplished using cold plasma techniques such as, radio frequency (RF), microwave, direct current, and the like. In one embodiment, the plasma is an RF plasma. The plasma treatment is controlled through many variables including, the type of gas, radio frequency, power, duration of treatment, and atmospheric pressure.

The present invention provides an improvement in the growth of cells on an RF plasma-treated polymer substrate without substantially changing the chemical composition on the surface. In the practice of the present invention, an inert gas is used to create nano/micro scale textures on the surface. Suitable inert gases include but are not limited to nitrogen, argon, and helium.

The RF plasma radio frequency may be, for example, up to 100 MHz, preferably in the range of 10-45 MHz. In one embodiment the radio frequency is about 13.56 MHz. In another embodiment, higher radio frequencies in the range of about 30 MHz to about 45 MHz can be used. In general, higher radio frequencies will increase ion bombardment activity and favor production of more dynamic masking activity, but lower radio frequencies are used to maintain a more uniform plasma. The radiofrequency may also be modulated, i.e. the frequency changed during the plasma treatment process. The radiofrequency will be tailored to the desired plasma characteristics.

The RF power is sufficient to effectively provide the wave-like features on the surface of the substrate, and can typically be from about 5 watts to about 500 watts (W). In one embodiment, the power ranges from about 100 W to about 500 W. In another embodiment, the plasma power range may be from 100 W to 400 W. In yet another embodiment, the power of plasma treatment is about 400 W.

The duration of plasma treatment is a sufficient period of time to effectively provide the wave-like features on the surface of the substrate, and may typically range from about 30 to about 90 minutes. In one embodiment, the duration of plasma treatment is from about 30 to about 40 min.

Optionally, modulation of the RF power level during the plasma treatment can be employed to modify the surface characteristics. Manual and/or programmed rapid and/or slow changes in the amount of radio frequency energy, i.e. power, being supplied to the plasma are possible. In general, the RF power is set at an initial level, for example 100 watts and subsequently increased and decreased by, for example, 25% from the original power setting, at specified intervals over the course of the etching period. Variations in power will affect the plasma's ability to alter a surface and can increase or decrease its ability to create nano-scale features on the surface.

The plasma treatment pressure may range, for example, from about 0.01 Torr to about 0.50 Torr. In one embodiment, plasma treatment pressure is about 0.03 Torr. The pressure will be sufficient to effectively provide the desired plasma characteristics.

The bias voltage applied to the sample to be etched, location of sample in the plasma chamber, and chamber pressure will affect the etching process and ultimately the surface morphology. In a preferred embodiment, polymeric or metallic samples are placed in the center of the plasma on a floating electrode and chamber pressure is 0.03 Torr. In still other embodiments, the electrode on which the sample is placed is electrically connected to a RF generator or a DC bias is applied.

The plasma chamber or equipment typically consists of a conventionally configured chamber than has an inlet and an outlet port. The inlet port is used for feeding in the gas of interest. The flow rate is controlled by a mass flow controller. The outlet port is connected to a vacuum pump and is used to evacuate the chamber to remove air and also remove excess gas flowing in. The chamber itself has metallic electrodes through which high voltage can be applied to generate a plasma with the gas of interest.

As a result of the RF plasma treatment, the surface of the silicone polymer substrate is modified without affecting the bulk substrate properties. By the surface of the substrate is meant the top layer of the substrate, particularly the top 50-100 micron layer of the substrate. The aggressive inert gas RF plasma treatment of the present invention creates wave-like features on the surface of the substrate as shown by atomic force microscopy. These wave-like features on the surface have a peak to peak distance and a height such that the surface provides improved cell attachment and growth. Therefore, the RF plasma treatment also increases the surface roughness of the substrate.

Suitable cells that may be grown on the surface include, but are not limited to, stem cells, progenitor cells, primary cells, transfected cells, and immortalized cells. In one embodiment the cells are human kidney derived cells.

The RF plasma treated polymer substrates of the present invention are particularly useful for the growth of human kidney-drived cells (hKDCs). Human kidney derived cells are isolated as described in US Patent Publication Number 2008/0112939, hereby incorporated by reference herein in its entirety.

Briefly, human kidney derived cells are isolated from a human kidney, suitable for organ transplantation. Blood and debris are removed from the kidney tissue prior to isolation of the cells by washing with any suitable medium or buffer such as phosphate buffered saline. Human kidney derived cells are then isolated from mammalian kidney tissue by enzymatic digestion. Combinations of collagenase, dispase, and hyaluronidase are used to dissociate cells from the human kidney tissue. Isolated cells are then transferred to sterile tissue culture vessels that are initially coated with gelatin. Human kidney derived cells are cultured in any culture medium capable of sustaining growth of the cells such as, but not limited to, renal epithelial growth medium (REGM).

Human kidney derived cells are passaged to a separate culture vessel containing fresh medium of the same or a different type as that used initially, where the population of cells can be mitotically expanded. The cells of the invention may be used at any point between passage 0 and senescence. The cells preferably are passaged between about 3 and about 20 times, more preferably are passaged about 4 to about 12 times.

In order to deliver the hKDC cells using a biodegradable scaffold, it is necessary to seed the scaffold with cells. In order to be effective, the cells have to adhere to the scaffold and proliferate. Kidney derived cells grown on synthetic, polyester scaffolds to yield tissue-like structures are useful as the basic building block materials for kidney tissue engineering applications. Therefore it is advantageous to develop methods that enhance cell adhesion and proliferation on biodegradable materials. In this invention, we have described a method to enhance hKDC adhesion and proliferation on biodegradable substrates. This can be used for tissue engineering and cell culture experiments.

The following example is illustrative of the principles and practice of the present invention, although not limited thereto.

### Examples

### Example 1

### Cell Adhesion on Plasma Treated PDMS

Polymer films of about 3 mm thickness were prepared from polydimethylsiloxane sold under the tradename SYLGARD 184 (Dow Corning, Midland, Mich.) by mixing the pre-polymer and catalyst in the ratio of 10:1 (total 22 gm weight) and pouring in a ″ diameter polystyrene petridish. The films were cured in a vacuum oven at 65 degrees Celsius for 4 hours. Then, the surfaces of the polymer films were physically modified using helium (He) inert gas plasma. Polymer films of approximately 2.5 cm² were placed into the plasma chamber. The plasma chamber was first evacuated of oxygen by a vacuum pump (15 min) and backfilled with Helium inert gas to a pressure of 34 mTorr. The plasma was then set to a specified power of, say, 100 W and turned on for a set duration of, say, 40 min. In order the determine the power and time conditions required for the plasma treatment to get optimal cell attachment, a range of powers, from 100-400 W, and times, from 10-90 min, were tested.

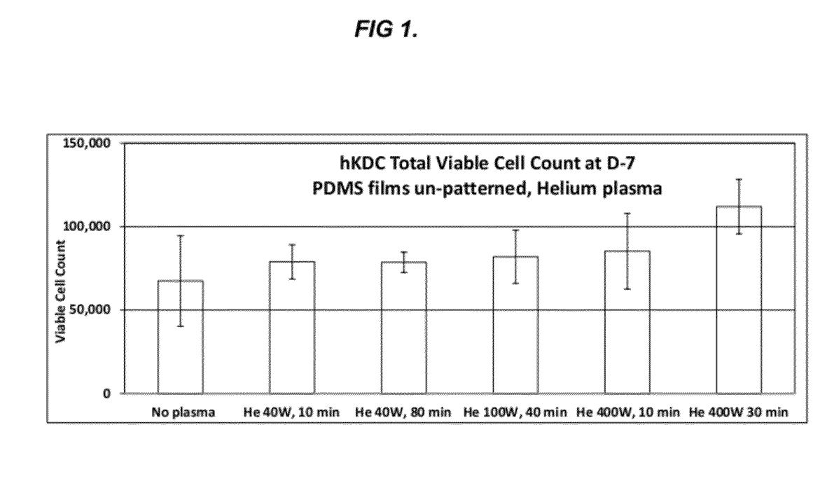

The cell response of human kidney-derived cells (hKDCs) on the films was evaluated by punching 9.5 mm samples from the films described above and placing them in culture wells using renal basal epithelial medium. The cells were seeded at a concentration of 100,000 cells/punch and incubated at 37 degrees Celsius overnight. The samples were then transferred to a new plate for cell growth and observed at day 7 with medium changes every 2-3 days. Cell attachment and proliferation was observed on these films to determine the biological response. FIG. 1 shows the cell counts on silicone samples that have been plasma treated under various power and time conditions as shown under the corresponding bars on the x-axis.

Cells on the polymer substrate were imaged by live-dead staining using the procedure below. The working solution was prepared by diluting Calcein AM (Live stain) and Ethidium homodimer (Dead stain) to 2 uM and 4 uM respectively in PBS (stains were combined at point of use). The media containing the polymer punches was aspirated once with PBS and the Live/Dead stain was added. This was incubated for at least 5 minutes at room temperature then imaged under a microscope. The live cells were seen as green in color and the dead cells were red.

To obtain additional information in some cases, the number of cells was quantified using the Guava cell counter. Media was aspirated from culture well and punches washed with PBS. 0.5 mL 0.25 percent Trypsin-EDTA was added to each punch and incubated at 37 degrees Celsius/5 percent CO2 for 5 min and then neutralized with 0.5 mL media. Cell-media suspensions were collected in a micro-centrifuge tube and tubes were centrifuged for 5 mins/5000 rpm. Cell pellets were resuspended in 0.5 mL (PBS/0.3 percent FBS). 0.150 mL cell suspension was transferred to a 96 well plate with each sample evaluated in triplicate. 0.050 mL Via Flex dye sol/well was added and samples analyzed on Guava instrument. 3 data points/punch was obtained and averaged to give the cell count.

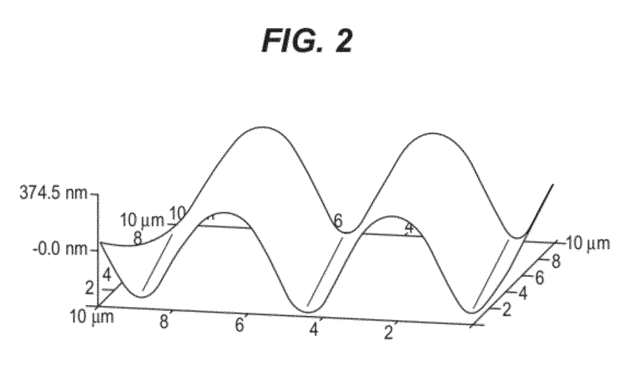

The plasma treatments and cell culture results indicate that the cell coverage was improved under higher power and longer time (duration) plasma treatments. Therefore, the 400 W 30 min treatment was more effective at increasing cell attachment than the 40 W 80 min treatment. It has been postulated that the plasma treatment alters the surface modulus while leaving the bulk modulus unchanged. As the energy of the plasma treatment increased (by increasing the power), the treatment was more effective at changing surface properties. At these higher energy surface treatments, characterization of the surface by atomic force microscopy showed the presence of regular wave-like features that have a peak to peak distance of about 4.5 micron and height of about 400 nm. Such surface structures imaged using an Atomic Force Microscope are shown in FIG. 2. The live dead staining confirmed the result showing that cells are densely populated on the surface and form “cellular pillars” on a cuboidal cell monolayer on the substrate.

The above descriptions are merely illustrative and should not be construed to capture all consideration in decisions regarding the optimization of the design and material orientation. It is important to note that although specific configurations are illustrated and described, the principles described are equally applicable to many already known stent configurations. Although shown and described is what is believed to be the most practical and preferred embodiments, it is apparent that departures from specific designs and methods described and shown will suggest themselves to those skilled in the art and may be used without departing from the spirit and scope of the invention. The present invention is not restricted to the particular constructions described and illustrated, but should be constructed to cohere with all modifications that may fall within the scope for the appended claims.

We claim:

1. A method of surface modification of a substrate, comprising the steps of:
providing a biocompatible, non-absorbable elastomeric polymer substrate, said substrate having a surface;
placing the substrate in an inert gas atmosphere; and,
applying an RF plasma treatment to the surface at a power of from about 100W to about 500 W for a length of time of about 30 to about 90 minutes,
thereby yielding a substrate having wave-like features on the surface.

2. The method of claim 1, where the biocompatible, non-absorbable elastomeric polymer is polydimethylsiloxane.

3. The method of claim 1, where the inert gas is selected from the group consisting of nitrogen, argon, and helium.

4. The method of claim 1, wherein the substrate comprises a medical device.

5. A surface-modified substrate made by the method of claim 1.
